(19) United States
(12) Patent Application Publication
(10) Pub. No.: US 2017/0230311 A1
(43) Pub. Date: Aug. 10, 2017

(54) BUFFER ALLOCATION AND USE FOR PACKET CLONING AND MANGLING

(71) Applicant: FREESCALE SEMICONDUCTOR, INC., Austin, TX (US)

(72) Inventor: TARAKA RAMA RAO NAYANAPATRUNI, Bangalore (IN)

(21) Appl. No.: 15/041,023

(22) Filed: Feb. 10, 2016

(51) Int. Cl. H04L 12/861

(52) U.S. Cl. CPC H04L 49/9057

(57) ABSTRACT

A method of cloning and mangling a received data packet in which an unused space of a receiving buffer can be used to accommodate at least some generated clone packets. Additional memory-use efficiencies can be realized by employing scatter-gather lists in the process of clone-packet generation when the size of the received data packet exceeds a predetermined threshold size. The method enables the corresponding network device to improve the packet-processing speed and memory use compared to those achievable with the use of conventional methods.

### BACKGROUND

The present invention relates to communications systems and, more particularly, to buffer allocation and usage for packet cloning and mangling at a network device.

The term “packet cloning” refers to the process of generating a new data packet that has the same payload as the original data packet but whose header might be modified in the process. The term “packet mangling” refers to the process of generating a new data packet whose payload is modified in some manner compared to the payload of the original data packet. The header of the “mangled packet” may or may not differ from the header of the original data packet.

Packet cloning and/or mangling is typically performed at an interface of a packet-based network before and/or after packet routing, with the header and/or payload of the data packet being modified for a specific constructive purpose, such as advanced network monitoring, multicasting in heterogeneous networks, lawful intercept for electronic surveillance, packet filtering, network address translation, etc. Packet cloning and mangling should be distinguished from packet corruption, where the data packet contents are modified unintentionally such as due to an equipment malfunction.

### BRIEF DESCRIPTION OF THE DRAWINGS

Embodiments of the present invention are illustrated herein by way of example and are not limited by the accompanying figures, in which like references indicate similar elements. Elements in the figures are illustrated for simplicity and clarity and have not necessarily been drawn to scale. Various aspects, features, and benefits of the disclosed embodiments will become more fully apparent, by way of example, from the following detailed description that refers to the accompanying figures, in which:

FIG. 1 is a schematic diagram that illustrates example packet-cloning and packet-mangling operations according to an embodiment of the invention;

FIG. 2 is a block diagram of a communication system according to an embodiment of the invention;

FIG. 3 is a flow chart of a conventional data-packet processing method that can be implemented by the communication system of FIG. 2;

FIG. 4 is a flow chart of a data-packet processing method that can be implemented by the communication system of FIG. 2 according to an embodiment of the invention;

FIG. 5 is a schematic diagram that illustrates buffer usage in the method of FIG. 4 according to an embodiment of the invention;

FIG. 6 is a schematic diagram that illustrates an alternative use of the same buffer in the method of FIG. 4 according to an embodiment of the invention;

FIG. 7 is a schematic diagram of another alternative use of the same buffer in the method of FIG. 4 according to an embodiment of the invention; and

FIG. 8 is a flow chart of a method of using packet transmission confirmations that can be implemented in the data-packet processing method of FIG. 4 according to an embodiment of the invention.

### DETAILED DESCRIPTION

Detailed illustrative embodiments of the present invention are disclosed herein. However, specific structural and functional details to which the disclosure refers are merely representative for purposes of describing example embodiments of the present invention. Embodiments of the present invention may be embodied in many alternative forms and should not be construed as limited to only the embodiments set forth herein.

As used herein, the singular forms “a,” “an,” and “the,” are intended to include the plural forms as well, unless the context clearly indicates otherwise. It further will be understood that the terms “comprises,” “comprising,” “has,” “having,” “includes,” and/or “including” specify the presence of stated features, steps, or components, but do not preclude the presence or addition of one or more other features, steps, or components. It also should be noted that, in some alternative embodiments, certain functions or acts may occur out of the order indicated in the figures.

Disclosed herein are various embodiments of a method of cloning and mangling a received data packet in which the unused space of the receiving buffer can be used to accommodate at least some of the generated clone packets. Additional memory-use efficiencies can be realized by employing scatter-gather lists in the process of clone-packet generation when the size of the received data packet exceeds a predetermined threshold size. The disclosed method advantageously enables the corresponding network device to improve the packet-processing speed and memory use compared to those achievable with the use of conventional methods.

One embodiment of the present invention is a method of processing data packets at a network device. The method comprises the steps of: storing a received data packet in a first buffer of the network device; determining whether or not an unused space of the first buffer is larger than a first threshold size; and generating a first clone packet corresponding to the received data packet in a first portion of the unused space of the first buffer if the unused space is larger than the first threshold size.

Another embodiment of the present invention is a network device that includes a memory having a plurality of buffers. The network device is operable to: store a received data packet in a first buffer of the plurality of buffers; determine whether or not an unused space of the first buffer is larger than a first threshold size; and generate a first clone packet corresponding to the received data packet in a first portion of the unused space of the first buffer if the unused space is larger than the first threshold size.

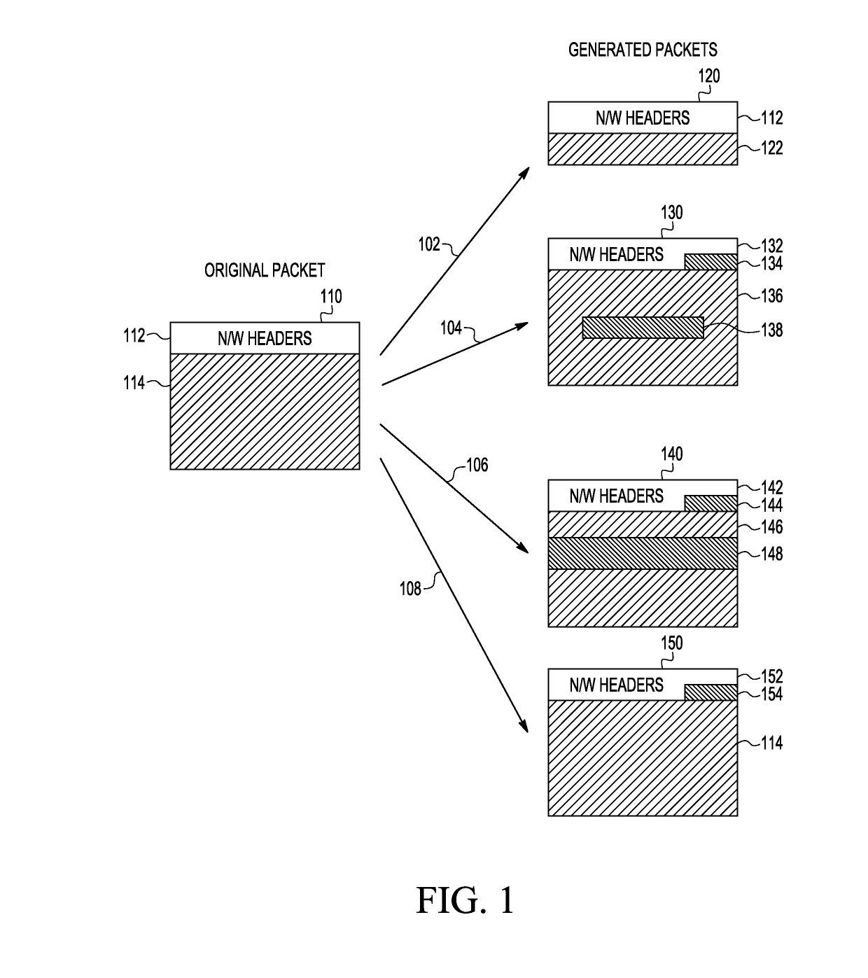

Referring now to FIG. 1, a schematic diagram that illustrates example packet-cloning and packet-mangling operations 102-108 according to an embodiment of the invention is shown. A person of ordinary skill in the art will appreciate that embodiments of the invention disclosed herein are nevertheless not limited only to the shown operations 102-108. For example, inventive concepts disclosed herein in reference to FIGS. 1-8 may similarly be applied to other desirable packet-cloning and packet-mangling operations not explicitly shown in FIG. 1.

An original data packet 110 includes a network (N/W) headers portion 112 and a payload portion 114. The operations 102-108 are applied to the original data packet 110 to generate the data packets 120, 130, 140, and 150, respectively.

The operation 102 generates the data packet 120 that includes (i) a copy of the network headers portion 112 as the network header and (ii) a payload portion 122. The payload portion 122 is generated by slicing the payload portion 114. As used herein, the term “slicing” refers to data removal, which causes the payload portion 122 to be smaller in size than the payload portion 114.

The operation 104 generates the data packet 130 that includes a network headers portion 132 and a payload portion 136. The network headers portion 132 is generated by inserting a sub-portion 134 to replace a corresponding sub-portion of the network headers portion 112. The payload portion 136 is generated from the payload portion 114 by masking data in a sub-portion 138 thereof. As used herein, the term “masking” refers to data modification that makes the data in the modified sub-portion undecodable at the destination node. An example masking operation may include replacing all data in the sub-portion 138 by zeros or encoding the data therein without providing the code key to the destination node.

The operation 106 generates the data packet 140 that includes a network headers portion 142 and a payload portion 146. The network headers portion 142 is generated by inserting a sub-portion 144 to replace a corresponding sub-portion of the network headers portion 112. The payload portion 146 is generated from the payload portion 114 by inserting a sub-portion 148 to replace a corresponding sub-portion of the payload portion 114.

The operation 108 generates the data packet 150 that includes a network headers portion 152 and a copy of the payload portion 114. The network headers portion 152 is generated by inserting a sub-portion 154 to replace a corresponding sub-portion of the network headers portion 112.

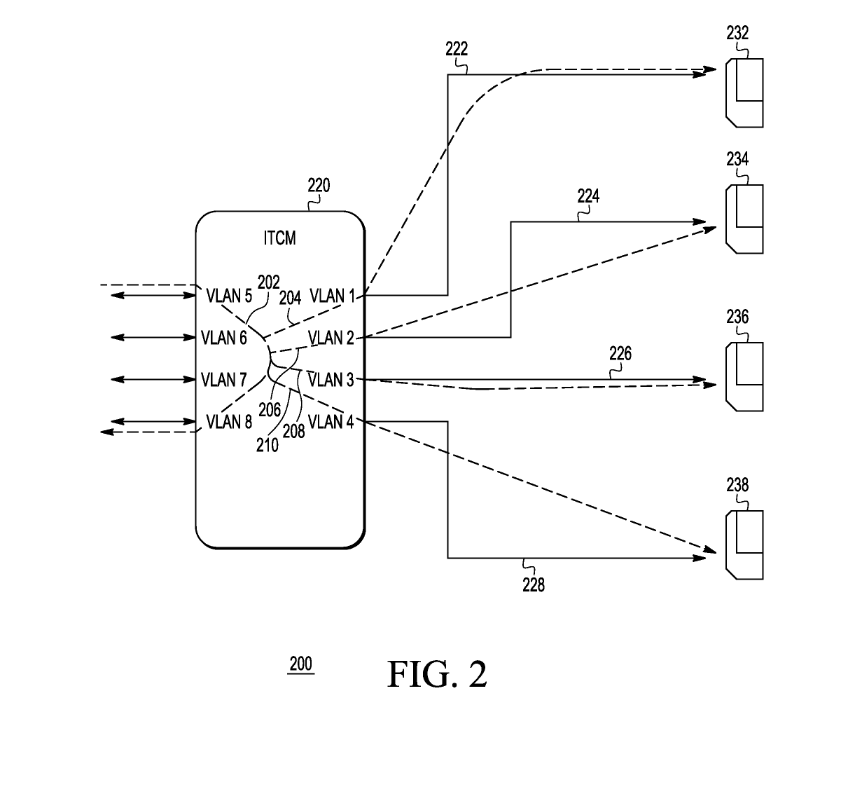

FIG. 2 is a block diagram that illustrates a communication system 200 according to an embodiment of the invention. The communication system 200 comprises an intelligent traffic classification manager (ITCM) 220 having a plurality of network ports labeled in FIG. 2 as VLAN1-VLAN8. The communication system 200 further comprises a plurality of traffic-management devices 232-238 that are connected by way of the network paths 222-228, as indicated in FIG. 2, to the network ports VLAN1-VLAN4, respectively, of the ITCM 220.

In an example embodiment, the traffic-management device 232 is a data-recording device. The traffic-management device 234 is a network analyzer. The traffic-management device 236 is an intrusion detection/prevention device. The traffic-management device 238 is a secure-socket-layer (SSL) analyzer. In various alternative embodiments, fewer or other and/or additional traffic-management devices may similarly be connected to the ITCM 220.

In an example configuration, the ITCM 220 receives a data packet 202 through the network port VLAN5. The ITCM 220 temporarily stores in its internal memory (not shown in FIG. 2) the received data packet 202 and applies appropriate packet-cloning and/or packet-mangling operations to the stored data packet 202 to generate the data packets 204-210. The ITCM 220 then applies the generated data packets 204-210, using the network ports VLAN1-VLAN4, to the network paths 222-228 for delivery to the traffic-management devices 232-238, respectively. The ITCM 220 releases the stored data packet 202 from the memory by applying that data packet to the network port VLAN8.

In an example configuration, the ITCM 220 may generate the data packet 204 by applying to the data packet 202 an operation that is similar to one of the operations 104 and 106 (FIG. 1). The ITCM 220 may generate the data packet 206 by applying to the data packet 202 an operation that is similar to the operation 102 (FIG. 1) or by completely stripping off the payload of the data packet 202. The ITCM 220 may generate the data packet 208 by applying to the data packet 202 an operation that is similar to the operation 108 (FIG. 1). The ITCM 220 may generate the data packet 210 by applying to the data packet 202 an operation that includes (i) header modification similar to that of the operation 108 and (ii) payload slicing configured to retain only secure data using an operation that is similar in part to the payload slicing of the operation 102 (see FIG. 1).

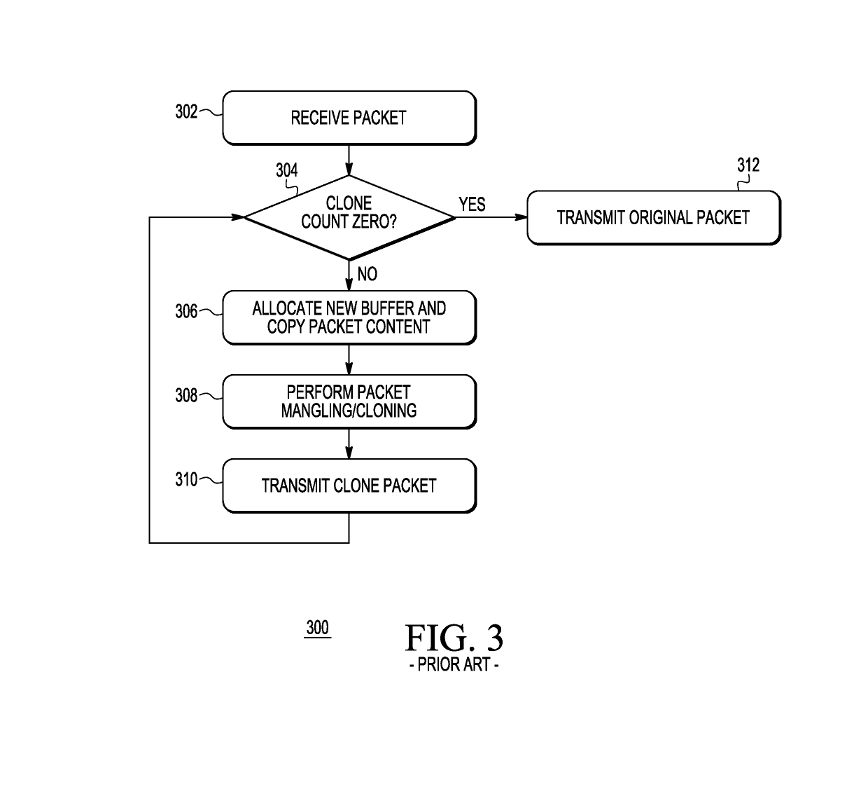

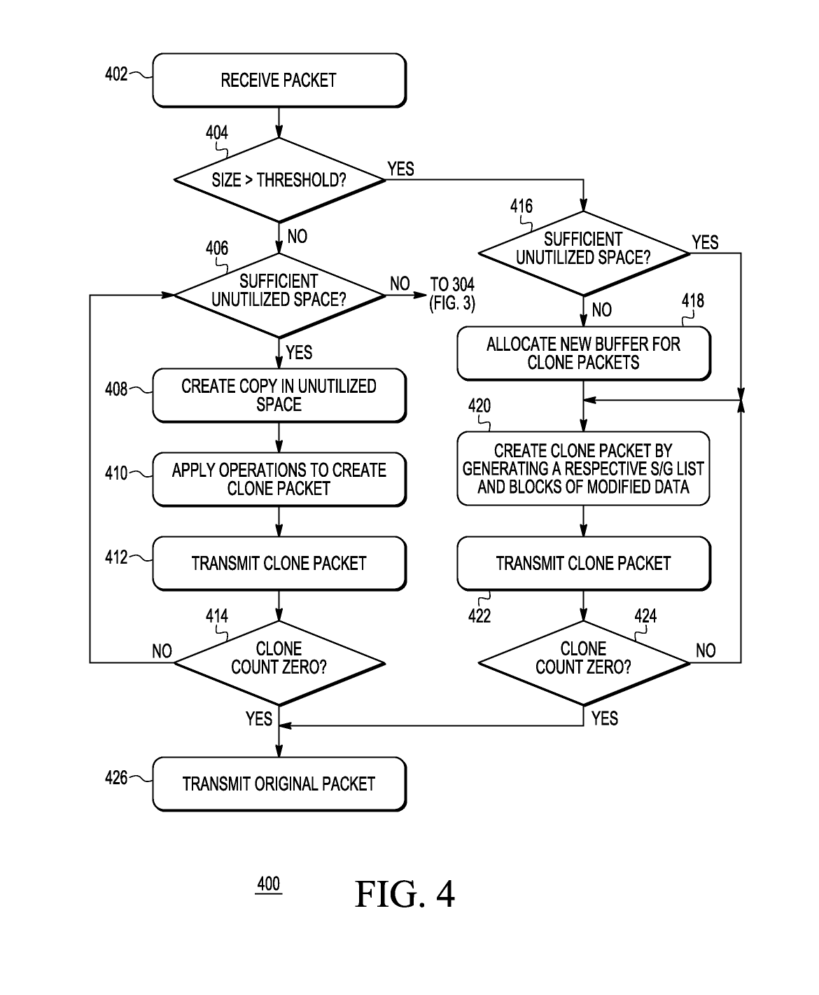

FIG. 3 is a flowchart that illustrates a conventional data-packet processing method 300 that can be implemented by the ITCM 220 (FIG. 2). The method 300 is directed at generating one or more new data packets by applying packet-cloning and/or packet-mangling operations, such as the operations 102-108 (FIG. 1). The method 300 can be implemented by the ITCM 220 (FIG. 2), e.g., as further described below in reference to FIG. 4.

At step 302 of the method 300, the ITCM 220 receives a data packet, such as the data packet 202 (FIG. 2). The ITCM 220 writes the received data packet into an internal memory buffer for temporary storage therein so that all desired packet-cloning and/or packet-mangling operations on the received data packet can be performed.

As used herein, the term “buffer” refers to a portion of the device's electronic memory that is allocated as a temporary holding place for the data that are being sent to or received from an external device or system. Typically, a buffer has a fixed size selected from a plurality of predetermined fixed sizes. For example, the following buffer sizes may be used: 2048 (2 k) bytes, 4096 (4 k) bytes, 8192 (8 k) bytes, 16384 (16 k) bytes, 32768 (32 k) bytes, 65536 (64 k) bytes, and 131072 (128 k) bytes. In some embodiments, other predetermined buffer sizes may also be used.

The receiving network device, such as the ITCM 220, typically has a buffer pool having buffers of different fixed sizes. The received data packet is typically written into an empty or unused buffer selected from the buffer pool and having the smallest size that can accommodate the entire received data packet. For example, the Ethernet format may use a Maximum Transferable Unit (MTU) that is 1500 bytes in size. This particular MTU size can be accommodated by and the corresponding received data packet can temporarily be stored in a 2 k buffer. As another example, the Ethernet format allows the use of jumbo frames for which the MTU size is 9000 Bytes. This particular MTU size can be accommodated by and the corresponding received data packet can temporarily be stored in a 16 k buffer.

Steps 304-310 of the method 300 are directed at generating one or more new data packets based on the data packet received at step 302. As already indicated above, these one or more new data packets are generated by applying the respective packet-cloning and/or packet-mangling operations. Each of such new packets is hereafter referred to as a “clone packet.” The number of clone packets that are yet to be generated for the data packet received at step 302 is referred to herein as the “clone count.”

At step 304, the current clone count is checked. If the clone count is positive, then the processing of the method 300 is directed to step 306, and the current clone count is decremented by one. If the current clone count is zero, then the processing of the method 300 is directed to step 312.

At step 306, a separate dedicated buffer from the pool of available buffers is allocated for the next clone packet. A copy of the packet received at step 302 is then written into the allocated buffer.

At step 308, one or more desired packet-cloning and/or packet-mangling operations are applied to the packet copy generated at step 306, which packet copy is altered by these operations and thereby transformed into the corresponding clone packet. This clone packet remains stored in the same buffer, i.e., the buffer allocated at step 306.

At step 310, the clone packet generated at step 308 is transmitted out, e.g., by being applied to an appropriate one of the network ports VLAN1-VLAN4 of the ITCM 220 as indicated in FIG. 2. The corresponding buffer is marked as being unused, which makes that buffer available for being selected from the pool of buffers, e.g., in the next instance of step 306. The processing of the method 300 is then directed back to step 304.

The processing loop comprising steps 304-310 is repeated until the clone count becomes zero. A person of ordinary skill in the art will understand that different packet-cloning and/or packet-mangling operations may be applied at different instances of step 308. As a result, different clone packets (e.g., as illustrated in FIG. 1) may be generated during different passes of the method 300 through the processing loop 304-310.

At step 312, the original data packet received at step 302 is released from the corresponding buffer, e.g., by being applied to the network port VLAN8 of the ITCM 220 as indicated in FIG. 2.

One problem with the method 300 is that at least step 306 thereof proves to be very costly and/or non-optimal in terms of the processing speed and memory use. This problem becomes especially disadvantageously pronounced when the received data packets have relatively large sizes.

This and certain other problems in the pertinent art can be addressed, e.g., using various embodiments disclosed herein below. In particular, some embodiments are able to bypass step 306 by relying on the unutilized space in the initial receiving buffer, i.e., the buffer into which the originally received data packet is written at step 302 of the method 300. For example, for the packet size of 256 bytes and with the smallest available buffer being a 2 k buffer, the unutilized space in the buffer is going to be 1792 (=2048-256) bytes. As another example, for the packet size of 9000 bytes and with the available fixed buffer sizes being the same as those in the above-mentioned buffer-pool example, the unutilized space in the buffer is going to be 7384 (=16384-9000) bytes. As these examples illustrate, the size of the unutilized space may be sufficiently large to be able to accommodate at least some of the generated clone packets. Additional efficiencies can advantageously be realized by employing scatter gather lists in the process of clone-packet generation, e.g., as further detailed below.

FIG. 4 is a flowchart that illustrates a data-packet processing method 400 that can be implemented by the ITCM 220 (FIG. 2) according to an embodiment of the invention. More specifically, the method 400 is directed at generating one or more new data packets by applying one or more packet-cloning and/or packet-mangling operations, such as the operations 102-108 (FIG. 1). Unlike the method 300 (FIG. 3), the method 400 does not always allocate a separate dedicated buffer to each clone packet by relying instead on the unutilized space in the initial receiving buffer. Depending on how the received packet is written into the initial receiving buffer, the unutilized space in that buffer may include the headroom or the tail room, or both, with respect to the position of the received data packet in the buffer. Due to at least this feature, the method 400 can advantageously improve memory utilization and speed up the clone-packet generation process for the ITCM 220 (FIG. 2) and/or similar network devices.

At step 402 of the method 400, the ITCM 220 receives a data packet, such as the data packet 202 (FIG. 2). The ITCM 220 writes the received data packet into a buffer for temporary storage therein so that all desired packet-cloning and/or packet-mangling operations on the received data packet could be completed.

At step 404, the size of the data packet received at step 402 is compared to a predetermined threshold size. If the packet size is greater than the predetermined threshold size, then the processing of the method 400 is directed to step 416. Otherwise, the processing of the method 400 is directed to step 406. In an example embodiment, the predetermined threshold size used at step 404 is 256 bytes. In alternative embodiments, other predetermined threshold sizes can also be used.

At step 406, the unutilized space in the buffer into which the received data packet was written at step 402 is compared with another predetermined threshold size. If the unutilized space is greater than the predetermined threshold size, then the processing of the method 400 is directed to step 408. Otherwise, the processing of the method 400 is directed to step 304 of the method 300 (FIG. 3). In an example embodiment, the predetermined threshold size used at step 406 is equal to the size of the data packet received at step 402. In alternative embodiments, other predetermined threshold sizes can also be used.

At step 408, an additional copy of the data packet received at step 402 is generated in the unutilized space of the same buffer.

At step 410, the copy generated at step 408 is appropriately modified to generate a corresponding clone packet, which remains stored in the same space. The modifications of the copy are performed, e.g., by applying a desired packet-cloning and/or packet-mangling operation. After the modifications are completed, the clone count is decremented by one.

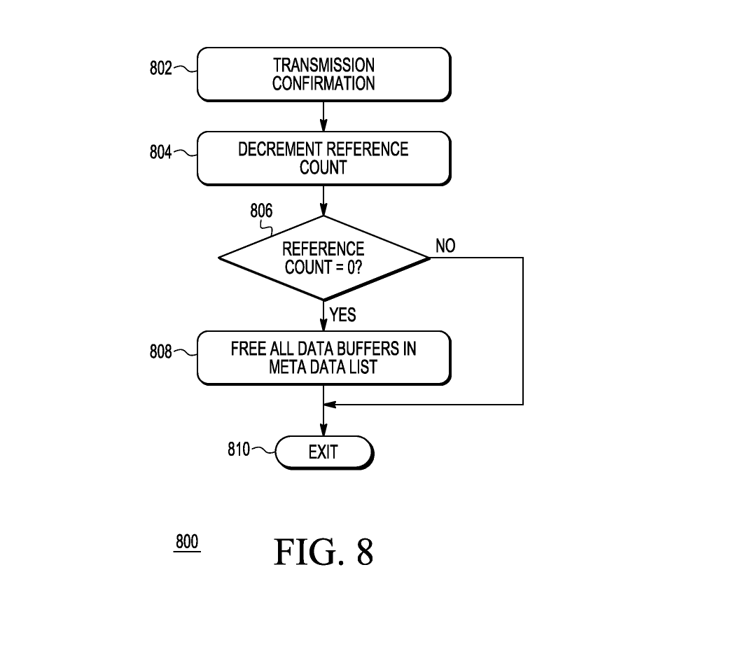

At step 412, the clone packet generated at step 410 is transmitted out, e.g., by being applied to an appropriate one of the network ports VLAN1-VLAN4 of the ITCM 220 as indicated in FIG. 2. The transmitter may also request that a packet delivery confirmation be sent back by the intended receiver. After the packet delivery confirmation is received, the clone-packet's buffer may be used to maintain metadata corresponding to the original packet. In some embodiments, step 412 may include the execution of a method of using packet transmission confirmations, e.g., as described in more detail below in reference to FIG. 8.

At step 414, the current clone count is checked. If the clone count is positive, then the processing of the method 400 is directed back to step 406. If the current clone count is zero, then the processing of the method 400 is directed to step 426.

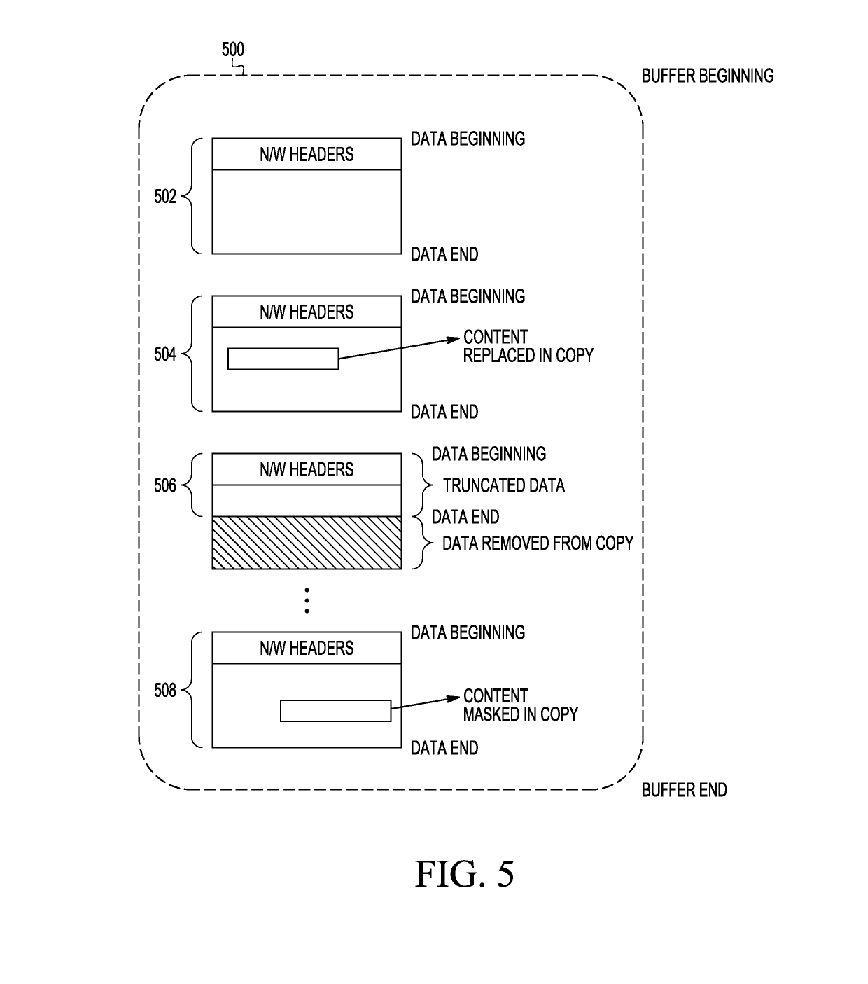

FIG. 5 is a schematic diagram that illustrates a buffer 500 that can be used in the processing loop 406-414 of the method 400 (FIG. 4) according to an embodiment of the invention. The buffer 500 is shown to contain the data packets 502-508. The data packet 502 is the initial data packet that is received and stored in the buffer 500 at step 402 of the method 400. The size of the buffer 500 is such that it has sufficient unutilized space, in the tail room of the buffer with respect to the position of the data packet 502, to accommodate n clone packets, where n is an integer greater than two.

During a first pass through the processing loop 406-414 of the method 400, the clone packet 504 is generated in a respective portion of the tail room of the buffer. More specifically, at step 408 of the processing loop, a copy of the data packet 502 is created in that portion of the tail room. Then, at step 410 of the processing loop, this copy of the data packet 502 is modified, e.g., by applying to it an operation that is similar in part to the operation 106 (FIG. 1). As a result, the copy of the data packet 502 is transformed into the clone packet 504.

During a second pass through the processing loop 406-414 of the method 400, the clone packet 506 is generated in a respective portion of the tail room of the buffer. More specifically, at step 408 of the processing loop, a copy of the data packet 502 is created in that portion of the tail room. Then, at step 410 of the processing loop, this copy of the data packet 502 is modified, e.g., by applying to it an operation that is similar to the operation 102 (FIG. 1). As a result, the copy of the data packet 502 is transformed into the clone packet 506.

During an n-th pass through the processing loop 406-414 of the method 400, the clone packet 508 is generated in a respective portion of the tail room of the buffer. More specifically, at step 408 of the processing loop, a copy of the data packet 502 is created in that portion of the tail room. Then, at step 410 of the processing loop, this copy of the data packet 502 is modified, e.g., by applying to it an operation that is similar in part to the operation 104 (FIG. 1). As a result, the copy of the data packet 502 is transformed into the clone packet 508.

Referring back to FIG. 4, at step 416 of the method 400, the unutilized space in the buffer into which the received data packet was written at step 402 is compared with the size required for all the clone packets, modified data, and scatter-gather lists. If the unutilized space is greater than the required size, then step 418 is bypassed, and the processing of the method 400 is directed to step 420. Otherwise, the processing of the method 400 is directed to step 418.

At step 418, a new buffer is allocated for the clone packet(s) to be generated. If step 418 is not bypassed, then steps 420-422 are performed using this new buffer. However, if step 418 is bypassed, then steps 420-422 are performed using the unutilized space of the initial buffer allocated at step 402.

At step 420, a clone packet is created by executing the sub-steps of (i) generating, in the allocated buffer space, one or more blocks of modified data corresponding to the data packet received at step 402 and (ii) generating a respective scatter-gather list that appropriately links up portions of the data packet received at step 402 and the one or more blocks of the modified data generated at sub-step (i). After the scatter-gather list is generated, the clone count is decremented by one.

As known in the pertinent art, a scatter-gather list defines a memory read request configured to gather data written into two or more noncontiguous (e.g., scattered) areas of the memory. Typically, a scatter-gather list comprises a sequence of pointers, each of which gives the location in the memory and the length of a respective contiguous data segment. The memory read request executed in accordance with the scatter-gather list thus enables the linked-up data to be read out as if these data were stored in and read from a single contiguous area of the memory. The use of scatter-gather lists is advantageously capable of reducing demands on the memory resources when the linked-up data segments are relatively large.

At step 422, the clone packet generated at step 420 is transmitted out, e.g., by being applied to an appropriate one of the network ports VLAN1-VLAN4 of the ITCM 220 as indicated in FIG. 2. Step 422 is similar to step 412 in that the transmitter may request a packet delivery confirmation and, after the packet delivery confirmation is received, cause the clone-packet's buffer to maintain metadata corresponding to the original packet. In some embodiments, step 422 may include the execution of the method illustrated in FIG. 8.

At step 424, the current clone count is checked. If the clone count is positive, then the processing of the method 400 is directed back to step 420. If the current clone count is zero, then the processing of the method 400 is directed to step 426.

At step 426, the original data packet received at step 402 is transmitted out, e.g., by being applied to the network port VLAN8 of the ITCM 220 as indicated in FIG. 2. After the packet delivery confirmation is received, the original packet and/or clone-packet's buffers (if any) are released with the help of the corresponding metadata, e.g., as indicated in reference to FIG. 8.

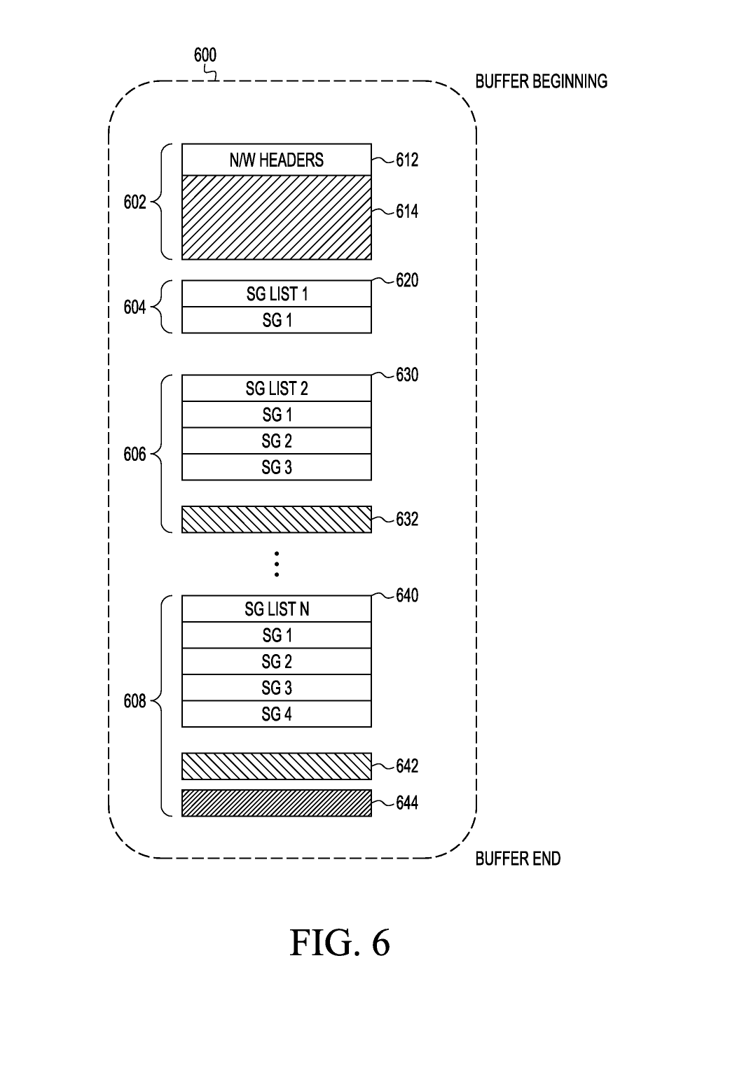

FIG. 6 is a schematic diagram that illustrates a buffer 600 used in the processing loop 420-424 of the method 400 (FIG. 4) according to an embodiment of the invention. More specifically, the data-packet processing illustrated in FIG. 6 corresponds to the situation in which step 418 is bypassed. The buffer 600 is shown to contain the data packets 602-608. The data packet 602 is the initial data packet that is received and stored in the buffer 600 at step 402 of the method 400. The data packet 602 comprises a network headers portion 612 and a payload portion 614. The size of the buffer 600 is such that it has sufficient unutilized space, in the tail room of the buffer, to accommodate n clone packets generated with the use of scatter-gather lists, where n is an integer greater than two.

During a first pass through the processing loop 420-424 of the method 400, the clone packet 604 is generated in a respective portion of the tail room of the buffer 600. The data packet 604 comprises a scatter-gather (SG) list 620 containing a single pointer labeled SG1. The pointer SG1 of the SG list 620 points to the network headers portion 612 of the data packet 602. Since the SG list 620 does not contain any other pointers, the data packet 604 is a clone packet that is generated from the data packet 602 by completely slicing off the payload portion 614.

During a second pass through the processing loop 420-424 of the method 400, the clone packet 606 is generated in a respective portion of the tail room of the buffer 600. The data packet 606 comprises (i) an SG list 630 containing the pointers labeled SG1-SG3 and (ii) a data sector 632 that contains data used for masking a corresponding sub-portion of the payload portion 614. The pointer SG1 of the SG list 630 points to the network headers portion 612 of the data packet 602. The pointer SG2 of the SG list 630 points to the data sector 632. The pointer SG3 of the SG list 630 points to the payload portion 614. Hence, the data packet 606 is a clone packet that is generated from the data packet 602 by applying to it an operation that is similar in part to the operation 104 (FIG. 1).

During an n-th pass through the processing loop 420-424 of the method 400, the clone packet 608 is generated in a respective portion of the tail room of the buffer 600. The data packet 608 comprises (i) an SG list 640 containing the pointers labeled SG1-SG4; (ii) a data sector 642 that contains data used for masking a corresponding sub-portion of the payload portion 614; and (iii) a data sector 644 that contains data used for replacing a corresponding sub-portion of the payload portion 614. The pointer SG1 of the SG list 640 points to the network headers portion 612 of the data packet 602. The pointer SG2 of the SG list 640 points to the data sector 642. The pointer SG3 of the SG list 640 points to the data sector 644. The pointer SG4 of the SG list 640 points to the payload portion 614. Hence, the data packet 608 is a clone packet that is generated from the data packet 602 by applying to it an operation that is similar in part to a combination of the operations 104 and 106 (FIG. 1).

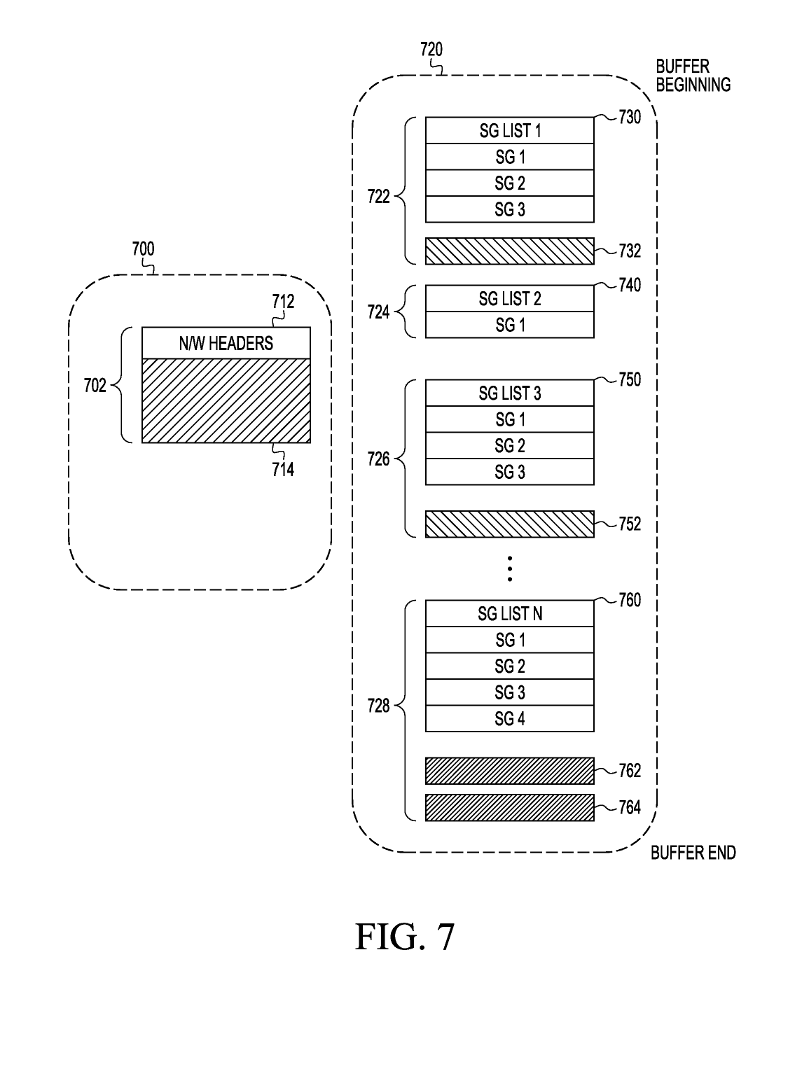

FIG. 7 is a schematic diagram that illustrates the buffers 700 and 720 that can be used in the processing loop 420-424 of the method 400 (FIG. 4) according to an embodiment of the invention. More specifically, the data-packet processing illustrated in FIG. 7 corresponds to the situation in which step 418 is not bypassed. The buffer 700 is the buffer allocated at step 402 of the method 400. As such, the buffer 700 is shown to contain the initial data packet 702. The buffer 720 is the additional buffer allocated at step 418 of the method 400. As such, the buffer 720 is shown to contain the clone packets 722-728. The size of the buffer 720 is such that it can accommodate n clone packets generated with the use of scatter-gather lists, where n is an integer greater than three.

During a first pass through the processing loop 420-424 of the method 400, the clone packet 722 is generated in a respective portion of the buffer 720. The clone packet 722 comprises (i) an SG list 730 containing the pointers labeled SG1-SG3 and (ii) a data sector 732 that contains data used for masking a corresponding sub-portion of the payload portion 714. The pointer SG1 of the SG list 730 points to the network headers portion 712 of the data packet 702. The pointer SG2 of the SG list 730 points to the data sector 732. The pointer SG3 of the SG list 730 points to the payload portion 714. Hence, the clone packet 722 is a clone packet that is generated from the data packet 702 by applying to it an operation that is similar in part to the operation 104 (FIG. 1).

During a second pass through the processing loop 420-424 of the method 400, the clone packet 724 is generated in a respective portion of the buffer 720. The clone packet 724 comprises an SG list 740 containing a single pointer labeled SG1. The pointer SG1 of the SG list 740 points to the network headers portion 712 of the data packet 702 stored in the buffer 700. Since the SG list 740 does not contain any other pointers, the clone packet 724 is a clone packet that is generated from the data packet 702 by completely slicing off the payload portion 714.

During a third pass through the processing loop 420-424 of the method 400, the clone packet 726 is generated in a respective portion of the buffer 720. The clone packet 726 comprises (i) an SG list 750 containing the pointers labeled SG1-SG3 and (ii) a data sector 752 that contains replacement data for a corresponding sub-portion of the payload portion 714. The pointer SG1 of the SG list 750 points to the network headers portion 712 of the data packet 702. The pointer SG2 of the SG list 750 points to the data sector 752. The pointer SG3 of the SG list 750 points to the payload portion 714. Hence, the clone packet 726 is a clone packet that is generated from the data packet 702 by applying to it an operation that is similar in part to the operation 106 (FIG. 1).

During an n-th pass through the processing loop 420-424 of the method 400, the clone packet 728 is generated in a respective portion of the buffer 720. The data packet 728 comprises (i) an SG list 760 containing the pointers labeled SG1-SG4; (ii) a data sector 762 that contains data used for masking a corresponding sub-portion of the payload portion 714; and (iii) a data sector 764 that contains data used for replacing a corresponding sub-portion of the payload portion 714. The pointer SG1 of the SG list 760 points to the network headers portion 712 of the data packet 702. The pointer SG2 of the SG list 760 points to the data sector 762. The pointer SG3 of the SG list 760 points to the data sector 764. The pointer SG4 of the SG list 760 points to the payload portion 714. Hence, the clone packet 728 is a clone packet that is generated from the data packet 702 by applying to it an operation that is similar in part to a combination of the operations 104 and 106 (FIG. 1).

FIG. 8 is a flowchart that illustrates a method 800 of using packet transmission confirmations that can be implemented in the data-packet processing method of FIG. 4 according to an embodiment of the invention. For example, in some embodiments, the method 800 can be incorporated into the processing implemented at one or more of steps 412, 422, and 426 of the method 400 (FIG. 4). In some embodiments, the method 800 can be implemented as a subroutine that is called up during the processing of the corresponding host step of the method 400.

At step 802 of the method 800, the packet transmission confirmation for the corresponding data packet is received from the appropriate circuit or device. As already indicated above, the data packet in question may be the data packet transmitted at one of steps 412, 422, and 426 of the method 400.

At step 804, the reference count is decremented by one. As used herein, the term “reference count” refers to the number of data packets that are yet to be transmitted out. The reference count includes both the clone packets and the original data packet.

At step 806, the current reference count is checked. If the reference count is positive, then the processing of the method 800 is directed to step 810. If the current reference count is zero, then the processing of the method 800 is directed to step 808.

At step 808, all buffers that are referred to in the metadata list(s) corresponding to the original data packet are freed up and made available for accepting other incoming data packets.

At step 810, the processing of the method 800 is terminated.

It will be further understood that various changes in the details, materials, and arrangements of the parts that have been described and illustrated in order to explain the nature of the invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. The terms “directly coupled,” “directly connected,” etc., imply that the connected elements are either contiguous or connected via a conductor for the transferred energy.

Although the steps in the following method claims are recited in a particular sequence with corresponding labeling, unless the claim recitations otherwise imply a particular sequence for implementing some or all of those steps, those steps are not necessarily intended to be limited to being implemented in that particular sequence.

1. A method of processing data packets at a network device, the method comprising:
storing a received data packet in a first buffer of the network device;
determining whether an unused space of the first buffer is larger than a first threshold size; and
generating a first clone packet corresponding to the received data packet in a first portion of the unused space of the first buffer if the unused space is larger than the first threshold size.

2. The method of claim 1, further comprising generating the first clone packet corresponding to the received data packet in a second buffer of the network device if the unused space of the first buffer is not larger than the first threshold size.

3. The method of claim 2, further comprising generating a second clone packet corresponding to the received data packet in the second buffer if the unused space of the first buffer is smaller than the first threshold size, wherein the second clone packet has a different data content than the first clone packet and occupies a different portion of the second buffer than the first clone packet.

4. The method of claim 1, further comprising generating a second clone packet corresponding to the received data packet in a second portion of the unused space of the first buffer if the unused space of the first buffer is larger than the first threshold size, wherein the second clone packet has a different data content than the first clone packet.

5. The method of claim 1, wherein the step of generating comprises:
generating a copy of the received data packet in the first portion of the unused space of the first buffer; and
modifying at least a portion of the copy to generate the first clone packet.

6. The method of claim 1, wherein the step of generating comprises generating a scatter-gather list that refers to at least a portion of the received data packet stored in the first buffer.

7. The method of claim 6, wherein:
the step of generating further comprises generating a block of data in the first portion of the unused space of the first buffer; and
the scatter-gather list refers to the block of data.

8. The method of claim 6, further comprising:
determining whether the unused space of the first buffer is larger than a second threshold size; and
comparing a size of the received data packet with the second threshold size; and
wherein generating the scatter-gather list is performed only if the size of the received data packet is larger than the second threshold size.

9. The method of claim 1, wherein the first clone packet differs from the received data packet in at least one of a header portion and a payload portion.

10. The method of claim 1, further comprising selecting the first buffer from a plurality of buffers of the network device based on a size of the received data packet, wherein the plurality of buffers comprises buffers of two or more different fixed sizes.

11. The method of claim 1, further comprising:
generating in the first buffer a predetermined number of clone packets corresponding to the received data packet; and
applying each of the clone packets to a respective network port of the network device for transmission to a respective external device.

12. The method of claim 11, wherein the predetermined number is greater than two.

13. The method of claim 11, further comprising transmitting the received data packet out of the first buffer of the network device using a network port of the network device that is different from a network port through which the received data packet was received by the network device.

14. The method of claim 13, further comprising:
requesting a transmission confirmation from each respective external device;
receiving the transmission confirmation from each respective external device; and
freeing the first buffer and any other buffers referred to in a metadata list corresponding to the received data packet.

15. The method of claim 1, further comprising:
generating a predetermined number of clone packets corresponding to the received data packet using at least two more buffers of the network device, wherein the at least two more buffers include the first buffer; and
applying each of the clone packets to a respective network port of the network device for transmission to a respective external device.

16. The method of claim 1, further comprising:
generating a predetermined number of clone packets corresponding to the received data packet using one or more buffers of the network device, wherein the one or more buffers do not include the first buffer; and
applying each of the clone packets to a respective network port of the network device for transmission to a respective external device.

17. The method of claim 1, wherein the first portion of the unused space of the first buffer is located in a tail room of the first buffer with respect to the received data packet.

18. The method of claim 1, wherein the network device is an intelligent traffic classification manager.

19. A network device comprising a memory that includes a plurality of buffers, wherein the network device is operable to:
store a received data packet in a first buffer of the plurality of buffers;
determine whether an unused space of the first buffer is larger than a first threshold size; and
generate a first clone packet corresponding to the received data packet in a first portion of the unused space of the first buffer if the unused space is larger than the first threshold size.

20. The network device of claim 19, wherein the network device is an intelligent traffic classification manager.
